(19) United States
(12) Patent Application Publication
(10) Pub. No.: US 2003/0230323 A1
(43) Pub. Date: Dec. 18, 2003

(54) Apparatus and method for improving scrubber cleaning

(75) Inventors: Wei-Ming You, Taipei (TW); Jih-Churng Twu, Chung-Ho city (TW); Fu-Su Lee, Tainan (TW); Han-Liang Tseng, Tainan (TW); Kan-Wha Chang, Tainan (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/172,090

(22) Filed: Jun. 14, 2002

(51) Int. Cl. B08B 3/02

(52) U.S. Cl. 134/33; 134/34; 134/144; 134/902; 134/153; 134/161

(57) ABSTRACT

A method and apparatus comprising a wafer platform which rotates a semiconductor wafer at a predetermined speed while being moved in a linear motion with respect to a stationary water jet nozzle spraying a water or fluid jet onto the wafer during a wafer scrubbing process. The coupled rotary and linear motions of the wafer facilitates through washing or rinsing of the wafer surface and spreads impact energy of water or fluid sprayed onto a wafer surface over a large surface area on the wafer, resulting in a substantial reduction of particles remaining at the center of the wafer after the wafer scrubbing operation and preventing or minimizing the likelihood of impact damage to the wafer during the wafer scrubbing process. In another embodiment, the water or fluid jet nozzle moves along a horizontal axis while the spinning wafer remains stationary.

### FIELD OF THE INVENTION

The present invention generally relates to a method for scrubber cleaning semiconductor wafers having a surface coating and more particularly, to an apparatus and method for ensuring thorough cleaning of the center of a semiconductor wafer during a scrubber cleaning process to prevent excess oxide growth on the center of the wafer.

### BACKGROUND OF THE INVENTION

In the fabrication process for semiconductor devices, numerous fabrication steps, as many as several hundred, must be executed on a silicon wafer in order to complete integrated circuits on the wafer. Since the processing of silicon wafers requires extreme cleanliness in the processing environment to minimize the presence of contaminating particles or films, the surface of the silicon wafer is frequently cleaned after each processing step. For instance, the wafer surface is cleaned after the deposition of a surface coating layer such as oxide or after the formation of a circuit by a processing step such as etching. A frequently-used method for cleaning the wafer surface is a wet scrubbing method.

In cleaning a wafer surface by a wet scrubbing method, a wafer is rotated at a high speed, i.e., at least about 200 RPM and preferably, about 1,000 RPM, simultaneously with a jet of high-pressure deionized water sprayed on top. The water jet is normally sprayed at a pressure of about 2,000-3,000 psi. The water movement on top of the wafer surface displaces any contaminating particles that are lodged on the wafer surface. One limitation of the wafer jet scrubbing method is that the process only moves particles from side to side in openings, such as oxide windows, without removing the particle. Furthermore, as the image size decreases, it becomes more difficult for water to reach the particles in openings because of increased surface tension.

It has also been noted that in a water jet scrubbing process conducted on a silicon wafer that is coated with an insulating material, i.e., an oxide layer as an inter-metal dielectric layer, some regions of the film are damaged at the wafer center by the cumulated stress from the water jet when the aperture size of the jet nozzle is too large or is distorted. The damaged film can be identified by a KLA scan, even though a large number of wafers must be tested since the probability of such damage is only about 10-30%.

FIG. 1 illustrates a silicon wafer 10 the upper surface of which is scanned in a waterjet scrubbing method using a conventional wafer scrubbing apparatus 8. The wafer 10 is normally positioned on a wafer platform 17 which is typically rotatably mounted on a wafer stage 16. The wafer platform 17 rotates the wafer 10 at a predetermined rotational speed, which may be between about 200 RPM and about 2,000 RPM. A water jet 22 of deionized water is ejected from a water jet nozzle 26 typically mounted on a nozzle rack 28 above the surface of the wafer 10. The water jet 22 has a water pressure of typically about 50 kg/cm². As it strikes the surface of the wafer 10 at an angle of typically about 45°, the water jet 22 is scanned along a top of the wafer surface by a lateral sweeping motion of the water jet nozzle 26 to define a generally curved or arcuate trace 12 which normally traverses the center 14 of the wafer 10, as illustrated in FIG. 2. The surface of the wafer 10 is scanned by the water jet 22 at least once, and preferably, several times. Centrifugal force acting on the water flow on the surface of the wafer 10 due to the rotating wafer platform 17 and wafer 10 removes contaminating particles or films from the surface of the wafer 10.

When the coating on the surface of the wafer is fused silicate glass (FSG) or other low-density film, stress defects tend to occur at the wafer center due to the cumulated stress from the water jet striking the wafer. Furthermore, organic particles tend to remain at the wafer center due to the reduced centrifugal force acting on the particles at the center of the wafer during the scrubbing process. These factors tend to increase the quantity of native oxide growth at the center region compared to other regions of the wafer, as measured by ellipsometer measurements. Moreover, the increased oxide thickness at the wafer center causes a reduced electrical charge at the wafer center as compared to the electrical charge at the wafer edge.

It has been found that horizontal movement of the wafer stage beneath the water jet nozzle during the scrubbing process provides a more uniform dispersement of the sprayed water along the entire surface of the disc. This has been found to substantially improve removal of organic particles from the wafer which would otherwise tend to remain at the wafer center due to reduced centrifugal force at the center, as well as reduce the water spray-induced damage to low-density film coatings at the wafer center by spreading the impact energy of the spray across a larger surface area on the wafer.

Accordingly, an object of the present invention is to provide an apparatus and method for substantially reducing the presence of particles remaining at the center of a semiconductor wafer after a wafer scrubbing process.

Another object of the present invention is to provide an apparatus and method for substantially reducing the possibility of wafer damage during a wafer scrubbing process.

Still another object of the present invention is to provide an apparatus and method for improving the efficacy of a scrubber cleaning process in the fabrication of integrated circuits on semiconductor wafers.

Yet another object of the present invention is to provide an apparatus and method which spreads impact energy of water or other fluid sprayed onto a wafer surface over a large surface area on the wafer to prevent or minimize the likelihood of impact damage to the wafer center during a wafer scrubbing operation.

A still further object of the present invention is to provide an apparatus and method for reducing excessive oxide growth at the center of a semiconductor wafer due to defects in the wafer scrubbing operation.

Yet another object of the present invention is to provide a method and apparatus which utilizes horizontal linear movement combined with a spinning motion of a semiconductor wafer to both reduce the presence of particles remaining at the center of a semiconductor wafer after a wafer scrubbing process and prevent or minimize the likelihood of cleaning water or fluid spray impact damage to the wafer center during the wafer scrubbing process.

Still another object of the present invention is to provide a method and apparatus which utilizes linear motion of a spinning wafer or a jet nozzle with respect to the other to disperse a pressurized fluid jet sprayed onto the surface of the wafer over substantially the entire surface of the wafer and thereby reduce the presence of particles remaining at the center of the wafer after a wafer scrubbing operation as well as reduce the possibility of spray-induced damage to the wafer center during the operation.

### SUMMARY OF THE INVENTION

These and other objects and advantages are provided in a method and apparatus comprising a wafer platform which rotates a semiconductor wafer at a predetermined speed while being moved in a horizontal linear motion with respect to a stationary jet nozzle spraying a water or fluid jet onto the wafer during a wafer scrubbing process. The coupled rotary and linear motions of the wafer facilitates through washing or rinsing of the wafer surface and spreads impact energy of water or fluid sprayed onto a wafer surface over a large surface area on the wafer, resulting in a substantial reduction of particles remaining at the center of the wafer after the wafer scrubbing operation and preventing or minimizing the likelihood of impact damage to the wafer center during the wafer scrubbing process. In another embodiment, the water or fluid jet nozzle moves along a horizontal axis while the spinning wafer remains stationary.

A method of the present invention may be carried out by the operating steps of providing a semiconductor wafer having a film layer coated on top thereof, positioning the wafer on a wafer holder or platform in a scrubbing chamber, and scanning a water jet in multiple passes across the film on the wafer while both rotating the wafer and moving the wafer holder or platform in a horizontal linear motion with respect to the water jet.

Another method of the present invention may be carried out by the operating steps of providing a semiconductor wafer having a film layer coated on top thereof, positioning the wafer on a wafer holder or platform in a scrubbing chamber, and scanning a water jet in multiple passes across the film on the wafer while both rotating the wafer and moving the water or fluid jet in a horizontal linear motion with respect to the spinning wafer.

The method of improving wafer scrubbing of the present invention may further include the steps of providing a jet nozzle and ejecting a jet of water or other scrubbing fluid from the jet nozzle onto the surface of the film coating the upper surface of the wafer. The semiconducting wafer may be a silicon wafer, and the film coated on the upper surface of the wafer may be fused silicate glass (FSG) or any other lower density film. The jet may be formed of deionized water and may have a water pressure of at least about 50 kg/cm².

The method of the present invention may further include the step of scanning a water or fluid jet in multiple passes across the surface of the disc as the disc is rotated at speeds of typically between about 200 RPM and about 2,000 RPM. The disc is simultaneously moved in a horizontal linear manner with respect to the water or fluid jet at speeds typically of from about 1 cm/min. to about 10 cm/min. The multiple passes may be made across a surface area corresponding to at least about one half of the disc upper surface area or across the entire disc upper surface area.

### BRIEF DESCRIPTION OF THE DRAWINGS

The invention will now be described, by way of example, with reference to the accompanying drawings, wherein:

FIG. 1 is an illustration of a conventional apparatus and method for cleaning a wafer positioned in a wet scrubber by a water jet traversing the top surface and through the center of the wafer;

FIG. 2 illustrates a trace made by a water jet traversing the top surface and through the center of a wafer, according to the conventional apparatus and method of FIG. 1;

FIG. 3 illustrates use of an apparatus and method of the present invention for cleaning a wafer positioned in a wet scrubber by a water jet traversing the top surface of the wafer;

FIG. 4 illustrates multiple traces made by a water jet traversing half of the top surface of a wafer, according to the apparatus and method of the present invention;

FIG. 5 illustrates multiple traces made by a water jet traversing the entire top surface of a wafer, according to the apparatus and method of the present invention; and

FIG. 6 illustrates another embodiment of the wafer scrubbing apparatus of the present invention.

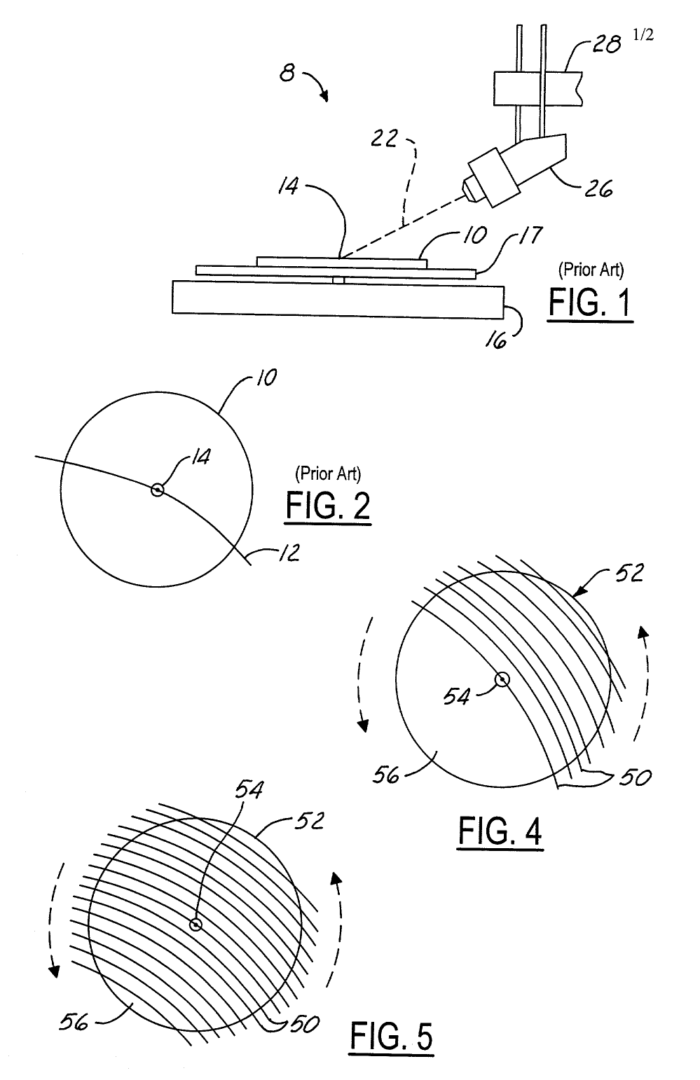

### DESCRIPTION OF THE PREFERRED EMBODIMENTS

The present invention comprises an apparatus and method for substantially improving the scrubber cleaning process of semiconductor wafers typically having a thin insulating film deposited on the upper surface thereof. The present invention facilitates more uniform scrubbing of all regions on the surface of the film, to prevent or minimize the possibility of film damage and remove organic film particles which otherwise have a tendency to remain on the film at the center region of the disc after the scrubbing operation and contribute to excessive oxide film growth at the wafer center.

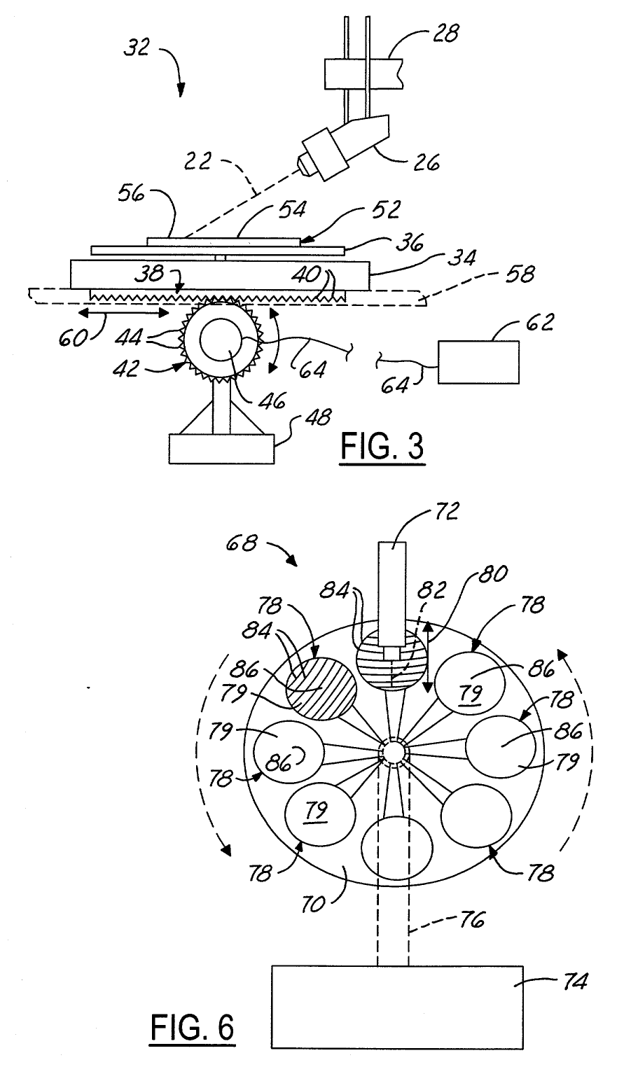

Referring initially to FIG. 3 of the drawings, a wafer scrubbing apparatus of the present invention is generally indicated by reference numeral 32 and typically includes a wafer stage 34, fitted with a rotatable wafer turntable or platform 36. An elongated rack 38, provided with multiple rack teeth 40, is mounted on the bottom surface of the wafer stage 34. The rack teeth 40 mesh with multiple pinion teeth 44 provided around the circumference of a circular pinion 42. The pinion 42 may be rotatably mounted on any suitable support 48 and is engaged by a synchronized motor 46 or other suitable powering mechanism for the pinion 42. The wafer stage 34 is further typically slidably or rollably mounted on horizontal track or tracks 58. Accordingly, the synchronized motor 46 can be operated to rotate the pinion 42 which, in turn, drives the wafer stage 34 via the rack 38 in a selected direction and at a selected speed along a substantially horizontal plane or axis, as indicated by the double-headed arrow 60. A process controller 62 with enabling software may be operably connected to the synchronized motor 46 typically by means of suitable wiring 64 for controlling the speed and direction of horizontal linear travel of the wafer stage 34 on the track or tracks 58. A jet nozzle 26 is mounted typically on a nozzle rack 28 above the surface 56 of a wafer 52 resting on the wafer platform 36, and remains stationary with respect to the wafer 52, wafer platform 36 and wafer stage 34 throughout a wafer-scrubbing process as hereinafter described. Alternatively, the jet nozzle 26 may be adapted for linear motion along a horizontal axis while the spinning wafer platform 36 and wafer 52 remain stationary. While the rack 38 and pinion 42 heretofore described are capable of driving the wafer stage 34 horizontally, it is understood that any other suitable mechanism known by those skilled in the art may be used to advance the wafer stage 34 horizontally along the track or tracks 58 as heretofore described.

Referring next to FIGS. 3 and 4, according to a typical method of using the wafer scrubbing apparatus 32 of the present invention, a wafer 52 having a film 56 coated on the upper surface thereof is initially positioned on the wafer platform 36. The film 56 may be fused silicate glass (FSG) or any other low-density insulative film coated on the wafer 52. As the wafer platform 36 is rotated on the wafer stage 34 at a speed of from about 200 rpm to about 2,000 rpm, and preferably, about 1,000 rpm, the synchronized motor 46 is operated to drive the wafer stage 34 along the tracks 58 at a speed of from about 1 cm/min. to about 10 cm/min., and preferably, at about 2.5 cm/min. Simultaneously, a fluid jet 22 which is typically but not necessarily deionized water is ejected from the jet nozzle 26 onto the film 56 on the surface of the wafer 52. The water jet 22 ejected from the jet nozzle 26 may have a pressure of at least about 50 kg/cm², and the jet nozzle 26 is typically moved in a lateral, sweeping motion to eject the water jet 22 onto the film 56 in such a manner as to define a curved trace 50 initially across the center 54 of the wafer 52. After that, multiple traces 50 are successively defined by the sweeping water jet 22 across at least one half of the surface area of the film 56 on the wafer 52 as illustrated in FIG. 4, as the wafer stage 34 is advanced horizontally along the tracks 58 for a distance which corresponds to the radius of the wafer 52. Accordingly, in the case of a 100 mm diameter wafer 52, the wafer stage 34 is advanced a total distance of 5 cm, which is the diameter of the wafer 52. Alternatively, the wafer stage 34 may be advanced along the tracks 58 for a distance which corresponds to the diameter of the wafer 52, typically 10 cm, in which case the sweeping water jet 22 defines multiple traces 50 across the entire surface area of the film 56 on the rotating wafer 52, as illustrated in FIG. 5. The multiple traces 50 may be made on the film 56 across the various sections of the wafer 52 either once or multiple times, as needed. It has been found that defining the multiple traces 50 across the film 56 on the wafer 52, facilitated by horizontal movement of the wafer stage 34, the laterally-sweeping motion of the jet nozzle 26 and the rotating motion of the wafer 52, provides a more uniform dispersement of the sprayed water or other scrubbing fluid along the entire surface of the film 56. This has been found to substantially improve removal of organic particles from the wafer 52 which would otherwise tend to remain at the wafer center 54 due to reduced centrifugal force at the wafer center 54, as well as reduce water or fluid jet-induced damage to the low-density film 56 particularly at the wafer center 54 by spreading the impact energy of the water jet 22 across a relatively large surface area on the film 56.

Referring next to FIG. 6, another embodiment of the wafer scrubbing apparatus of the present invention is generally indicated by reference numeral 68 and includes a rotatable multi-wafer turntable or platform 70 which is drivingly engaged by a drive motor or other drive mechanism 74 through a drive belt or chain 76. A jet nozzle 72 is mounted above the platform 70 for directing a water or fluid jet 82 sequentially onto each of multiple wafers 78 supported on the platform 70 as the platform 70 is rotated by operation of the drive motor 74. Furthermore, the jet nozzle 72 is mounted for bidirectional horizontal axial movement above and along the radius of the platform 70, as indicated by the arrow 80. This axial motion of the jet nozzle 72 may be accomplished by operation of a rack and pinion arrangement (not shown), as heretofore described with respect to the wafer scrubbing apparatus 32 of FIG. 3, or any other suitable method known by those skilled in the art. It is understood that the wafer platform 70 instead of the jet nozzle 72 may be adapted for horizontal axial movement in an alternative embodiment of the invention. Accordingly, defining multiple traces 84 of the water jet 82 across a film 79 on the upper surface of the wafer 78 is facilitated by horizontal axial movement of the water jet nozzle 72, combined with the rotating motion of the platform 70. This provides a substantially uniform dispersement of the sprayed water along the entire surface of the film 79 on the wafer 78. Accordingly, removal of organic particles from the wafer 78 which would otherwise tend to remain at the wafer center 86 due to reduced centrifugal force at the wafer center 86, is significantly enhanced. Moreover, water jet-induced damage to the low-density film 79 on each wafer 78, particularly at the wafer center 86, is substantially minimized or eliminated by spreading the impact energy of the water jet 82 across a relatively large surface area on the film 79.

While the preferred embodiments of the invention have been described above, it will be recognized and understood that various modifications can be made in the invention and the appended claims are intended to cover all such modifications which may fall within the spirit and scope of the invention.

Having described our invention with the particularity set forth above, we claim:

What is claimed is:

1. A wafer scrubbing apparatus for cleaning a wafer, comprising:
a rotatable wafer platform for receiving the wafer;
an advancement mechanism operably engaging said wafer platform for advancing said wafer platform in a substantially horizontal plane; and
a jet nozzle disposed above said wafer platform for dispensing a supply of liquid onto the wafer.

2. The apparatus of claim 1 wherein said advancement mechanism comprises a rack carried by said wafer platform, a pinion engaging said rack and a motor engaging said pinion for rotating said pinion, whereby said rack advances said wafer platform in said substantially horizontal plane.

3. The apparatus of claim 1 further comprising a wafer stage and wherein said wafer platform is rotatably carried by said wafer stage.

4. The apparatus of claim 3 wherein said advancement mechanism comprises a rack carried by said wafer stage, a pinion engaging said rack and a motor engaging said pinion for rotating said pinion, whereby said rack advances said wafer stage and said wafer platform in said substantially horizontal plane.

5. The apparatus of claim 1 wherein said jet nozzle is mounted for lateral movement above said wafer platform.

6. The apparatus of claim 5 wherein said advancement mechanism comprises a rack carried by said wafer platform, a pinion engaging said rack and a motor engaging said pinion for rotating said pinion, whereby said rack advances said wafer platform in said substantially horizontal plane.

7. The apparatus of claim 5 further comprising a wafer stage and wherein said wafer platform is rotatably carried by said wafer stage.

8. The apparatus of claim 7 wherein said advancement mechanism comprises a rack carried by said wafer stage, a pinion engaging said rack and a motor engaging said pinion for rotating said pinion, whereby said rack advances said wafer platform in said substantially horizontal plane.

9. A method of cleaning a wafer, comprising:
providing a wafer scrubbing apparatus comprising a rotatable wafer platform and a jet nozzle disposed above said wafer platform;
positioning the wafer on said wafer platform;
rotating said wafer platform;
moving said jet nozzle in a lateral motion;
moving a selected one of said wafer platform and said jet nozzle along a horizontal axis substantially transverse to said lateral motion of said jet nozzle; and
dispensing a fluid jet from said jet nozzle onto the wafer.

10. The method of claim 9 wherein said fluid jet comprises a deionized water jet.

11. The method of claim 9 wherein said rotating said wafer platform comprises rotating said wafer platform at a speed of at least about 200 r.p.m.

12. The method of claim 11 wherein said fluid jet comprises a deionized water jet.

13. The method of claim 9 wherein said moving a selected one of said wafer platform and said jet nozzle along a horizontal axis comprises moving said selected one of said wafer platform and said jet nozzle at a speed of from about 1 cm/min. to about 10 cm/min. along said horizontal axis.

14. The method of claim 13 wherein said fluid jet comprises a deionized water jet.

15. The method of claim 13 wherein said rotating said wafer platform comprises rotating said wafer platform at a speed of at least about 200 r.p.m.

16. The method of claim 15 wherein said fluid jet comprises a deionized water jet.

17. The method of claim 9 wherein said dispensing a fluid jet from said jet nozzle comprises dispensing a fluid jet from said jet nozzle at a pressure of at least about 50 kg/cm².

18. The method of claim 17 wherein said rotating said wafer platform comprises rotating said wafer platform at a speed of at least about 200 r.p.m.

19. The method of claim 18 wherein said moving a selected one of said wafer platform and said jet nozzle along a horizontal axis comprises moving said selected one of said wafer platform and said jet nozzle at a speed of from about 1 cm/min. to about 10 cm/min. along said horizontal axis.

20. A wafer scrubbing apparatus for cleaning a wafer, comprising:
a wafer platform for receiving the wafer;
a jet nozzle disposed above said wafer platform for dispensing a supply of liquid onto the wafer; and
wherein said jet nozzle is movable in a substantially horizontal plane above said wafer platform.
